(19) United States
(12) Patent Application Publication
(10) Pub. No.: US 2012/0185303 A1
(43) Pub. Date: Jul. 19, 2012

(54) Method of advertising, marketing and promoting organized sport(s)

(76) Inventor: Eftim Cesmedziev, San Pedro, CA (US)

(21) Appl. No.: 12/930,808

(22) Filed: Jan. 18, 2011

(51) Int. Cl. G06Q 30/00; G06Q 90/00

(52) U.S. Cl. 705/14.1; 705/500

(57) ABSTRACT

A sport team(s) offers its properties for sport team(s) sponsors, where code(s) advertising, marketing and promoting system is created and offers to sport fan(s) and sport fan association(s), where sport fan(s) earn points and/or money that may be used for attending/watching the future game(s) or for other fan(s) needs.

### RELATED APPLICATION

Not applicable

### STATEMENT REGARDING STATE SPONSORED RESEARCH OF DEVELOPMENT

Not applicable

### NOTICE OF MATERIAL SUBJECT TO COPYRIGHT PROTECTION

A portion of the material in this patent document is subject to copyright protection under copyright laws of the United States and other countries. The owner of the copyright rights has no objection to the facsimile reproduction by anyone of the patent document or the patent disclosure, as it appears in the United States Patent and Trademark Office publicly available file of records, but otherwise reserves all copyright rights whatsoever. The copyright owner does not hereby waive any of its fights to have this patent document maintained in secrecy, including without limitation its rights pursuant to 37 C.F.R., section 1.14.

### FIELD OF THE INVENTION

The present invention generally relates to advertising, marketing and promoting organized sport(s).

### BACKGROUND OF THE INVENTION

Organized sport(s) need steady revenue to keep up with the top competition and to buy quality sport players who can produce better game, which will brings more sponsors and fans. Sport teams want to increase the value of its properties that are offers to the sport sponsors, such as advertising on sport players' shirts, advertising at the stadium, offers its advertising, marketing and promoting broadcasting rights and the like. All those varieties of advertising platforms and programs, as well producing good games by the sport team attract people and money.

From the other side, sport team may have sport fans organized in sport fan organization(s) or not. They play very important part during the game. They enjoy the game because they love the game. Because of frequency of playing the games, sport team fan(s) sometime is/are not financially strong to keeps up with all games. For that reason sport team(s) offers deals to its sport team fan(s). Sport team sponsor(s) also want to be involved in the business between the sport team(s) and sport team fan(s). For that reason sport team sponsors creates programs for the sport team fans.

Sport team fan(s) needs program(s) by the sport team(s) and/or sport team sponsor(s) that can help them with expenses for watching the game(s). Currently, there is a lack of a reliable structure and business model in the organized sport(s) where:
sport fan(s) and sport fan organization(s) can advertise and promote its self and get better deals from the sport team sponsor(s), sport apparel(s) manufacturer(s), sport team organization(s);
sport team organization(s) can offer an advertising, marketing and promoting model of doing business to its sponsors to reach most of the sport team fan(s) and sport team fan association(s) around the world.

Therefore, a primary object of the present invention is to provide a new business model for advertising, marketing and promoting in organized sport(s) that will improved the relation between the sport fans and their needs, the organized sport(s) team and sport team sponsor(s). With implementing of this invention, the relation between the sport team, its sponsor(s) and the team fan(s) will be more united.

### BRIEF SUMMARY OF THE INVENTION

The general purpose of the present invention, which will be described subsequently in detail later, is to provide method of advertising, marketing and promoting the organized sport(s), heretofore as a prior art and novel features that which is not anticipated, rendered obvious, suggested, or even implied by any of the prior art, either alone or in any combination thereof.

One embodiment of the present invention include:
a people that are playing in a sport team(s), called players, where they are coached by a coach or team of coaches, in order to perform better on the sport field(s);
sport team organization(s) that adequately and functionally organized all aspects of the sport team(s);
sport fan(s) and sport fan organization(s) that support its sport team(s);
sponsor(s) that support the sport team(s) and its players, the sport league(s) and/or the sport(s) in general.

One embodiment of the present invention includes person/people that is/are sport fan(s) of a sport team(s) or not, where that person/people (“sport team fan(s)”) may be part of the organized structure of sport team(s) fan association(s), follows the requirements of the sport fan organization(s) and adequately and functionally communicate with all relevant parties known in the art of computer, internet, advertising, marketing, e-mailing, website(s), secured internet banking transactions, organizations and all known ways of communication as it is known in the art of variety of relevant industries.

Another embodiment of the invention is that sport fan(s) and sport fan(s) association(s) are adequately and functionally connected with the sport team(s), where sport fan association(s) may be part of the sport team(s) or not, and sport fans association(s) are adequately and functionally connected with the sport team sponsor(s) and/or organized sport team league, as is know in the advertising, marketing, business and all other relevant industries.

Another embodiment of the present invention includes sport apparel manufacturer(s) that may create logo(s) that is representing the certain sport(s) and/or sport fan association(s) next to manufacturers logo(s), or sport fan association(s) logo(s) to be part of the sport apparel(s) manufacturing logo(s).

Another embodiment of the invention includes sport fan association(s) clearly advertised on sport team apparel(s) and and/or any other advertising platforms, as is known in the arts in advertising and marketing industry.

Another embodiment of the present invention includes a code(s) advertising, marketing and promoting system that is shown at various places that can be easily been seen by the sport fan(s) that attend the game at the stadium and/or can be broadcasted over the TV, satellite TV, cable TV, internet, handheld devices, printed materials, radio, satellite radio and all other advertising and marketing medias.

Another embodiment of the present invention includes the sport team fan(s) who lives in the area where sport team sponsor(s) do not have developed its business yet, where the sport team sponsor(s) may sale its code(s) advertising, marketing and promoting system right for doing business to the companies that do local business around the address of living of the sport team fan(s) offering product(s) and service(s) as is known in the art in the business, advertising, marketing and all other relevant industries.

In this respect, before explaining at least one embodiment of the invention in greater detail, it is to understand that invention is not limited in its application to the details and steps of construction and to arrangements of the components/steps set forth in the following description. This invention is capable of other embodiments and of being practiced and carried out in various ways. In addition, it is to be understood that the phraseology and terminology employed herein is for the purpose of description and should not be regarded as limiting.

As such, those skilled in the art will appreciate that the conceptions, upon which this disclosure is based, may readily be utilized as a basis for the designing of other structures, devices, methods and systems for carrying out several purposes of the present invention. It is important, therefore, that the claims be regarded as including such equivalent constructions insofar as they do not depart from the spirit and scope of the present invention.

Further, the purpose of the foregoing abstract is to enable the Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application not is it intended to be limiting as to the scope of the invention in any way.

### DETAILED DESCRIPTION OF THE PREFERRED EMBODIMENTS

Aspects of the invention may be practiced using any suitable arrangement of the elements of the invention. In the following description, for purposes of explanation and not limitation, specific details are set forth in order to provide a thorough understanding of the present invention. However, it will be apparent to one skilled in the art that the present invention may be practiced in other embodiments that depart from these specific details. In other instances, detailed descriptions of well-known methods and devices are omitted so as to not obscure the description of the present invention with unnecessary details.

As is already known, the sport team(s) organization(s), its players, its fans and its sponsors are making the business circle that happens every time when the game is played. They all have a different role in the game, but they are all connected ether for the love of the game or for business purposes.

The sport team(s) organization(s) is created by many departments, but most important for the game are the game player(s). The sport team(s) players produce the game on the field by playing the game(s). If they produce better game(s), then with its product(s) they will bring more people to watch them, either at the stadium and/or through some kind of media that broadcast the game(s). That product, which the sport team(s) players are producing, attracts money and brings sponsor(s) where the sport team(s) organization(s) can use it for their needs.

The sport team(s) sponsor(s) may offers product(s), services(s) and/or money to create revenue for the sport team(s) and the sport team organization(s) and/or a sport league(s), where sport sponsor(s) use the sport team(s) properties, such as, but not limited to player's apparel(s), advertising platform(s) at the stadium(s), offers its advertising, marketing and promoting rights for broadcasting the game(s), on a website(s) and e-mail(s) as an advertising and marketing platforms, and the like, for advertising, marketing and promoting its businesses.

The sport fan(s) want to watch a good game, good product that players are producing, to enjoy the atmosphere at the stadium, to have food(s) and drink(s) while they watch the game(s), to have a better seat at the stadium. They are ready to pay for this because they love the excitement that the game produces.

There is a problems that this invention is addressing:
can a sport fan(s) financially be able to pay for ticket(s) to watch the game(s), to have food(s) and drink(s) every time when they watching the game(s)?
can a sport fan(s) financially be able to travel and covers the travel expenses along with its team to watch the game(s) while they are playing out of its town every other game?
can a sport fan(s) who live far away from the stadium—maybe in different country—have same or similar benefits like the sport fan(s) from same sport team(s) who lives close to the sport fan(s) stadium?
can a sponsor(s) reach most of the sport team fan(s) and get more money from its sponsorship of the sport team(s) and/or sport league(s)?

The purpose of the present invention is to create an adequate and functional new business model for advertising, marketing and promoting organized sport(s). This description of the invention is for illustration purposes only.

Every member of a sport fan(s) association(s) that is accepted by the sport team(s) organization(s) and its sponsor(s), need to have own secured and personal e-mail fan address, personal and secure bank account(s) and other requirements from the sport fan association(s), sport team(s) and/or sport team sponsor(s), where the sport fan(s) can adequately and functionally communicate with all relevant parties, to receive and send information, filling out offered surveys, get product(s) and service(s) at discounted prices and other activities known in the art of computer, internet, business, advertising, marketing, promoting, e-mailing, website(s), text messaging(s), secured internet banking transactions and all ways of communication as it is known in the art of all related industries.

With mutual agreement(s) between sport fan(s), sport fan association(s), sport team(s) and sport team sponsor(s), sport team(s) and/or the sport team sponsor(s) may contact sport team fan(s) and its association(s) with surveys related to the personal life of the sport team fan(s), to know more about sport team fan(s) needs and to offer a solutions for their needs with sport sponsor(s) service(s) and product(s), such as but not limited to issue a credit/debit/gift card(s) for covering the sport fan(s) daily living expenses that sport fan(s) needs to cover, as is known in the banking, communication, advertising, marketing and all other related industries.

With daily use of the credit/debit/gift card(s) by the sport team fan(s), which is adequately and functionally issued to the fan(s), the sport team fan(s) get product(s), service(s), points and/or money every time when he/she use the card(s) for purchasing goods that he/she needs them in sport fan(s) life, where earned points and/or money can go to sport team fan(s) personal and secure account(s), and they can be used for future activities related to watching the game(s), such as, but not limited to, for covering the traveling expenses for watching the game(s), better seats at the stadiums, free food(s) and drink(s) and other needs and the like, where the sport team sponsor(s) adequately and functionally create successful program(s) for sport team fan(s) and fan(s) needs, as is already known in the art of banking, advertising, marketing, business and all other relevant industries. In this way, the sport fan(s) can cover its daily expenses and can earn more points and/or money for the next game, can watch more often the games, can support his/her team. That will bring steadier stream of revenue for fan(s) sport team(s), where sport team(s) may bring better player(s) that produce better product(s), better game and more fan(s) and fun. From other side, the sport team(s) sponsor(s) will be more attracted to be the sponsor(s) of the sport team fan(s). That will create unity between the “trinity”: sport team organization(s), sport team fan(s) and sport team sponsor(s).

As an appreciation to the sport fan(s) and the sport fan association(s), the sport team(s) and sport sponsor(s) may create logo(s) and/or other form of representing the sport fan(s) association(s), where sport fan(s) association(s) will be clearly advertised on the sport team(s) apparel and/or any other advertising platforms, as is known in the arts in advertising and marketing industry.

The sport team(s) and/or sport team sponsor(s) may adequately and functionally develop variety of programs, such as, but not limited to, using the website(s), e-mailing(s), text messages(s) as an advertising and marketing platform(s), and the like, where the sport fan(s) will need to participate if he/she want to be part of the sport fan association(s) represented on sport team(s) apparel and and/or any other advertising platforms, such as, but not limited to;
a yearly membership of the program where sport team fan(s) receive special certificate for that year and chance to enter in the history of the sport team(s) as a official sport fan(s) of the sport team(s),
creating memorabilia and sentimental value for the sport team fan(s),
offering credit card(s) and other programs that are personally created for every sport team fan(s) according its needs,
offering mortgages to the sport team fan(s) and other programs, and the like.

Similarly, the sport apparel(s) manufacturer(s) may also create logo(s) for its sport fan(s) association(s), (example: logo with words NIKE SOCCER FANS or NIKE FANS) which is representing the certain sport next to sport apparel(s) manufacturer(s) logo or as an additional part of that logo(s), where the relation between the organized sport fan(s) and the sport apparel manufacturer(s) may develop other program(s) offered to the fan(s), as is know in the art of related industries.

The sport team(s) may develop code(s) system for advertising, marketing and promoting goods at the sport team(s) properties, and offer it to its sponsor(s). The code(s) advertising, marketing and promoting system will help sport team sponsor(s) to reach more potential customers who are watching the game(s). The code(s), adequately and functionally made from combination of number(s), letter(s), symbol(s) and the like, may be adequately and functionally placed at various advertising platforms that are located on the sport team(s) properties, such as, but not limited to sport team(s) apparel(s), advertising platforms at the stadiums, as a part of the advertising, marketing and promoting broadcasting rights of the sport team(s), website(s), e-mailing(s), text messaging(s) and the like, etc., where code(s) can be easily been seen by the sport team fan(s) that attend the game at the stadium and/or can be seen, heard, read over the TV screens, satellite TV, cable TV, internet, internet TV and/or handheld devices, cell phones, printed materials, radio, satellite radio and other advertising and marketing medias. Then, upon seeing, hearing and/or reading the code(s), the sport team fan(s) have a limited time to adequately and functionally enter the code(s) into his/her account(s) using adequately and functionally connected device(s) to the sport team fan(s) account(s), and claim the benefits, such as, but not limited to points, money, discounts and other programs that are known in the art of advertising, marketing, banking, internet, computer and all other related industries.

Here is one practical example of implementing the invention: if the sport team sponsor is a bank, the bank advertise it self using one or more advertising platforms that are placed in and around the stadium(s), on the sport team(s) apparels and the like. There, along with the bank advertising message(s), the bank adequately and successfully place code(s) made from letters, numbers and/or symbols, alongside with its advertising message on the same advertising platform. Sport team fan(s) that is at the stadium may see that code(s) and in a limited time and/or one entry per code(s), the sport fan(s) needs to enter successfully and adequately the code(s) to its account (where time and date of entry is recorded) using adequately and functionally connected devices to his/her account—like cell phone or the like—along with the other requested information as a prove that the sport team fan(s) was attending the game. The code(s) may be different for every game and they are controlled by the bank and/or sport team(s), according their requirements, as is known in advertising, marketing and other industries. Entering the code(s) with other requested information at sport fan(s) account by the sport fan(s), the sport fan(s) get points and/or money, which fan(s) can redeem it for its future needs related to the sport activities, such as, but not limited to, for covering the travel expenses for watching a games, food(s) and drink(s) at the stadium(s), better seats at the stadium and the like. At the same time when the game is played, the game may be broadcasted using one or more broadcasting medias and show the game around the world. The sport team fan(s) that lives far away from the stadium and/or chose to watch the game over broadcasting medias, will watch the game and will see the same advertising platforms that are placed around the stadium and/or other places, with adequately placed code(s) on them. Then, the sport team fan(s) have a limited time to enter successfully and adequately the code(s) to its account (where time and date of entry is recorded) using adequately and functionally connected device(s) to fan(s) account according the all rules that are required, needs adequately and functionally to enter the code(s) to its account using adequately and functionally connected devices to its account, along with the other information required as a prove that the sport team fan(s) was watching the game. In this way that sport fan(s) can earn points and/or money from the sponsor(s) and redeem the benefits that are offer to him/her, as is known in art of advertising, marketing and all other related industries.

For those sport fans who lives in the area where team sport team sponsor(s) do not have developed its business yet, the sport team sponsor(s) may sale its code(s) advertising, marketing and promoting system rights for doing business to the companies that do local business around the address of living of the team sport fan(s), offering the discounts and other product(s) and service(s) as is known in the art in the business, advertising, marketing and all other related industries.

The sport team(s) sponsor(s) and/or sponsor(s) in generally, may use same code(s) system of advertising, marketing and promoting its business, using the code(s) advertising, marketing and promoting system where they decide to use it and are not related with the sport(s), as is known in the art of advertising, marketing, banking, business, promoting and all other related industries.

Having described the principles of my invention, it should be apparent that these embodiments of the invention are basic embodiments and that more embodiments may be added within the invention. From the foregoing, it will be appreciated that, although specific details and embodiments of the invention have been described herein for the purposes of illustration, various modifications may be made without deviating from the spirit and scope of the invention. Accordingly, I claim all embodiments and modifications as many come within the scope and the spirit of the following claims.

1. Method of advertising, marketing and promoting organized sport(s) comprising:
(a) sport team(s), including, but not limited to, sport(s) player(s);
(b) sport team fan(s) and sport team fan association(s);
(c) sport team sponsor(s);
(d) business relation between sport team(s), sport team fan(s)/fan association(s) and/or sport team sponsor(s);
(e) code(s) advertising, marketing and promoting system;
(f) sport team(s), sport team(s) fan(s) and sport team fan association(s), sport team sponsor(s) and/or code(s) advertising, marketing and promoting system are adequately, functionally and successfully all connected together as one advertising, marketing and promoting business working unit;

2. A method as recited in claim 1, wherein said sport team(s), further includes:
(a) sport team(s) that is adequately and functionally organized organization(s) created by many departments and may have sport fan(s) association(s) that is part of the sport team(s) or not;
(b) sport team(s) that have sport apparel(s) where sport apparel(s) manufacturer(s) may create logo(s) that is representing the certain sport(s) and/or sport fan(s) manufacturer(s) association(s) next to manufacturer(s) logo(s), develop entertaining program(s) and any kind of game(s) and/or game(s) show(s) with the code(s) advertising, marketing and promoting system implemented in it, together with and manufacturer(s) logo(s);

3. A method as recited in claim 1, wherein said sport team fan(s) and sport team fan association(s), further includes:
(a) sport team fan(s) and sport team fan association(s) where sport team fan(s) is accepted by sport fan association(s), sport team organization(s) and/or sport team sponsor(s), where sport fan(s) need to have own secured and personal e-mail address, personal and secure bank account and other requirements from the sport fan association(s), sport team(s) and/or sport team sponsor(s), where the sport fan(s) can adequately and functionally communicate with all relevant parties, to receive and send information, filling out survey(s), get product(s) and service(s) at discounted price and other activities known in the art of computer, internet, advertising, marketing, e-mailing(s), website(s), social networking(s), TV, radio, secured internet banking transactions, develop entertaining program(s), any kind of game(s) and/or game show(s) with the code(s) advertising, marketing and promoting system implemented in it, and other ways of communication as it is known in the art of all related industries;
(b) with daily use of the credit/debit/gift card(s) by the sport fan(s), which is/are adequately and functionally issued to the sport team fan(s), the sport team fan(s) get product(s), service(s), points and/or money every time when fan(s) use the card(s) for purchasing goods that fan(s) needs them in its life, where earned points and/or money is collected to sport team fan(s) personal and secure account(s), and it can be used for future activities related for watching the game(s), such as, but not limited to, for covering the traveling expenses for watching the game(s), better seats at the stadium(s), free food(s) and drinks) at the stadium and other needs and the like, where the sport team sponsor(s) adequately and functionally create successful program(s) for sport team(s) fan(s) and fan(s) sport(s) needs, as is already known in the art of banking, advertising, marketing, business and all other relevant industries;

4. A method as recited in claim 1, wherein said sport team sponsor(s), further includes:
(a) sport team sponsor(s) that sponsor(s) may be sponsor(s) on one sport team(s) and/or sport team(s) organized league(s), as is know in the advertising, marketing, business and all other relevant industries;
(b) sport team(s) sponsor(s) that can contact sport fan(s) and its association(s) with survey(s) related to the personal life of the sport team fan(s), to know more about sport team fan(s) needs and to offer a solutions for their needs with their service(s) and product(s), such as but not limited to, issue a credit/debit/gift card(s) for covering the fan(s) daily living expenses that sport team fan(s) needs to cover, as is known in the banking industry, advertising, marketing, promoting, business and all other related industries;
(c) sport team sponsor(s) and/or sponsor(s) in generally, may use same code(s) advertising, marketing and promoting system in its business(es), using the code(s) advertising, marketing and promoting system where they decide to use it and/or in program(s) that are not related with the sport, as is known in the art of advertising, marketing and promoting industry;

5. A method as recited in claim 1, wherein said the sport team(s) and sport team sponsor(s), further includes:
(a) the sport teams) and sport team(s) sponsor(s) that they may create logo(s) and/or other form of representing the sport team fan(s) and sport team fan association(s), where sport team fan association(s) will be clearly advertised on the sport team(s) apparel(s) and/or any other advertising platform(s), as is known in the arts of advertising, marketing and all other relevant industries;
(b) the sport team(s) and sport team(s) sponsor(s) that may develop variety of programs where the sport team fan(s) will need to participate if he/she want to be part of the sport team(s) fan(s) association(s) represented on sport team(s) apparel(s) and and/or any other advertising platform(s), such as, but not limited to;
yearly membership of the program(s) where sport fan(s) receive special certificate(s) for that year, and the like;
creating memorabilia and sentimental value for the sport team fan(s),
offering credit card(s) and other programs that are personally created for every sport fan according its need, mortgages to the sport fan and other programs,
develop entertaining and/or commercial program(s) and any kind of game(s) and/or game(s) show(s) with the code(s) advertising, marketing and promoting system implemented in them, and the like;
(c) the sport team(s) and sport team sponsor(s) that the sport team sponsor(s) may sale its code(s) advertising, marketing and promoting system rights for doing business to the companies that do local business around the address of living of the team sport fan(s) in the places where the sport team(s) sponsor do not have developed its own business yet, offering product(s) and service(s) as is known in the art in the business industry and all other related industries;

6. A method as recited in claim 1, wherein said code(s) advertising, marketing and promoting system, further includes:
(a) adequately and functionally developed code(s) advertising, marketing and promoting system by the sport team(s) and/or other parties, and offer them to its sponsor(s);
(b) code(s) are adequately and functionally made from combination of number(s), letter(s), symbol(s) and the like, and they may be adequately and functionally placed at various advertising platform(s) alongside with the advertising message on the same advertising platform(s), at the sport team(s) properties, such as, but not limited to sport team(s) apparels, advertising platforms at the stadiums, as a part of the broadcasting rights of the sport team(s), website(s), e-mailing(s), text messaging(s) and the like, where code(s) can be easily been seen by the sport fan that attend the game at the stadium and/or can be seen, heard, read over the TV screens, satellite TV, cable TV, internet and internet TV and/or handheld devices, cell phones, printed materials, radio, satellite radio, develop entertaining program(s) and game(s)/and/or game(s) show(s) with the code(s) system implemented in them, and all other advertising and marketing medias;
(c) upon seeing, hearing and/or reading the code(s), the sport fan(s) who is at the stadium have limited time adequately and functionally to enter the code(s) according rules that are required, into fan(s) account(s) using adequately and functionally connected devices to fan(s) account(s), alongside with the other required information as a prove that the sport fan(s) was attending the game(s) and to claim the benefits, such as, but not limited to points, money, discounts and other programs that are known in the art of advertising, marketing, banking, internet, entertaining, computer and all other related industries;
(d) the code(s) may be different for every game and they are controlled by the sponsor(s) and/or sport team(s), according their desires and needs, as is known in advertising, marketing and all other industries;
(e) entering the code(s) with other requested information at sport fan(s) account by the sport fan(s), the sport fan(s) get points and/or money, which fan(s) can redeem it for the its future needs related to the sport activities or not;
(f) at the same time when the game(s) is played, the game(s) may be broadcasted using one or more medias adequately and functionally created for that, and show the game(s) around the world, where the advertising message(s) may be seen alongside with the code(s);
(g) the sport fan(s) that lives far away from the sport team(s) stadium and/or choose to watch/listen the game(s) over the broadcasted medias, will watch/listen the game(s) and will see the same advertising platforms that are placed around the stadium(s) and/or other places, with adequately placed code(s) on them;
(h) the sport fan that is watching/listening the game(s) over the broadcasting media and/or choose to watch/listen the game(s) over the broadcasted medias, have limited time to enter the code(s) according rules that are required, into fan(s) account using adequately and functionally connected devices to fan(s) account(s), alongside with the other information required for prove that the sport fan(s) was watching/listening the game(s), and to earn points and/or money from the sponsor(s) and redeem the benefits that are offer to the fan(s);
(i) code(s) are adequately and functionally created from combination of number(s), letter(s), symbol(s) and the like, that are adequately and functionally made from any material, light, created and controlled by hardware and software, made in any shape(s) and color(s), and any other way, and are placed adequately, functionally and successfully at various advertising platforms alongside with the advertising message(s) on the same advertising platform;

7. A method as recited in claim 1, wherein said the sport team(s), further includes:
(a) the sport team(s) have also player(s) who produce the game(s) and the players may create logo(s) and/or other form of representing the player's fan(s) and/or player's fan(s) association(s), where player's fan association(s) will be clearly advertised on the player(s) sport team(s) apparel(s) and/or any other advertising platform(s), as is known in the arts in advertising, marketing and all other relevant industries;
(b) the player(s) may develop variety of programs where the player's fan(s) will need to participate if they want to be part of the player's fan association(s) represented on player(s) sport team(s) apparel(s) and and/or any other advertising platforms, such as, but not limited to;
yearly membership of the program(s) where player's fan(s) receive special certificate(s) for that year, and the like;
develop entertaining and/or commercial program(s) and game(s) and/or game(s) show(s) with the code(s) advertising, marketing and promoting system implemented in them, and the like;
creating memorabilia and sentimental value for the player's fan(s);
player(s) may use any form of communication program(s) using the code(s) advertising, marketing and promoting system, such as, but not limited to, website(s), email(s), social networking(s), text messaging(s), and the like;
(c) the player(s) may sale its code(s) advertising, marketing and promoting system rights for doing business to other parties and/or to be part of other parties, offering product(s) and service(s) as is known in the art in the business and all other related industries;
(d) the player(s) may use the code(s) advertising, marketing and promoting system for its own advertising, marketing and promoting program(s), adding the code(s) next to player's name at the sport apparel(s) and/or other advertising platforms, and the like;

8. A method as recited in claim 1, wherein said sport team(s), sport team fan(s) and sport team fan association(s), sport team sponsor(s) and code(s) advertising, marketing and promoting system are adequately, functionally and successfully all connected as one advertising, marketing and promoting business working unit, further includes sport team(s), sport team(s) fan(s) and sport team fan association(s), sport team sponsor(s) and code(s) advertising, marketing and promoting system that are adequately, functionally and successfully all connected as one advertising, marketing and promoting business working unit that have several steps that are adequately, functionally and successfully connected together where more steps may be added, some steps may be skipped and/or some steps may be modified, where:
(a) sport team(s) and sport team player(s) have a business agreement(s) accepted from all relevant sides as is known in the art of business, advertising, marketing and all other relevant industries;
(b) sport team(s) and sport team sponsor(s) have a business agreement(s) accepted from all relevant sides as is known in the art of business, advertising, marketing and all other relevant industries;
(c) sport team sponsor(s) and sport team player(s) have a business agreement(s) accepted from all relevant sides as is known in the art of business, advertising, marketing and all other relevant industries;
(d) sport team(s) and sport team fan(s), sport team fan(s) and/or sport team(s) fan organization(s) have an agreement(s) accepted from all relevant sides as is known in the art of business, advertising, marketing and all other relevant industries;
(e) sport team player(s) and its fan, fans and/or fan organization(s) have an agreement(s) accepted from all relevant sides as is known in the art of business, advertising, marketing and all other relevant industries;
(f) sport team sponsor(s) and sport team fan, sport team fans, sport team fan organization(s), player(s) fan, player(s)'s fan and/or player(s)'s fan organization(s) may have an agreement(s) accepted from all relevant sides as is known in the art of business, advertising, marketing and all other relevant industries;
(g) sport team(s), sport team player(s), sport team sponsor(s) and sport team fan(s), sport team fan(s), sport team fan organization(s), player(s) fan(s) and/or player(s)'s fan(s) organization(s) may have an agreement(s) accepted from all relevant sides as is known in the art of business, advertising, marketing and all other relevant industries;
(h) according the agreements mention above, the sport team(s) and/or sport team(s) player(s) place the sport team sponsor(s) message(s) with adequately and functionally implemented the code(s) advertising, marketing and promoting system on it, where code(s) are adequately and successfully placed at the sport team(s)/sport team player(s) property, such as, but not limited to sport team(s) apparel(s), as a part of the broadcasting rights of the sport team(s), website(s), e-mailing(s), text messaging(s) and the like, where code(s) can be easily been seen by the sport fan(s) that attend the game at the stadium and/or can be seen, heard, read over the TV screens, satellite TV, cable TV, internet and internet TV and/or handheld devices, cell phones, printed materials, radio, satellite radio, develop entertaining program(s) and any kind of game(s) and/or game(s) show(s) with the code(s) advertising, marketing and promoting system implemented in it, and other broadcasting, advertising and marketing medias, as is know in all related industries;
i) sport team fan(s) and/or sport team player(s) fan(s) may see the sport team(s) sponsor(s) message(s) with adequately and functionally implemented the code(s) advertising, marketing and promoting system on it, regardless if the sport team fan(s) and/or sport team player(s) fan(s) is at the stadium watching/listening the game and/or watching the game(s) using any broadcasting media that broadcast the game(s);
(j) sport team(s) fan(s) and/or sport team(s) player(s) fan(s) have limited time to enter successfully and adequately the code(s) to its account using adequately and functionally connected devices to his/her account along with other required information as a prove that sport team fan(s) and/or sport team player(s) fan(s) was watching the game(s), as is know and regulated in the art of advertising, marketing, promoting, business and all other related industries;
(k) upon adequately and successfully entering the code(s) at its account, the sport team fan(s) and/or sport team player(s) fan(s) may get points and/or money, which fan(s) can redeem it for its future needs related to the sport activities, such as, but not limited to, for covering the travel expenses for watching a game(s), food(s) and drink(s) at the stadium, better seats at the stadium(s) and the like, and/or for other fan(s) needs;
(l) the above mention steps may be repeated without limits, some steps to be skipped and/or added new steps, and all that is regulated according the rules and requirements that are mention in the agreements, as is know in the art of advertising, marketing, promoting, business and all other related industries;

9. A method as recited in claim 1, wherein said code(s) advertising, marketing and promoting system, further includes:
(a) adequately and functionally developed code(s) advertising, marketing and promoting system is created from few major steps, such as, but not limited to:
(a1) adequately and functionally created code(s) according the advertising platform where the code(s) will be implemented,
(a2) adequately and functionally placed code(s) at various advertising platform(s) alongside with the advertising message on the same advertising platform(s),
(a3) adequately and functionally broadcasting the advertising platform(s) with the code(s) implemented in them, using any known adequately and functionally created medias,
(a4) person that adequately and functionally see, hear, read the advertising message(s) with the code(s) implemented in them, and use the code(s) according the requirements,
(a5) adequately and functionally collecting the benefits by the person who is using the code(s),
(a6) this steps may be adequately and functionally repeated without limits and new steps may be added, modify the existing ones and any other combination between the steps within the scope and the spirit of the method;
(b) the code(s) advertising, marketing and promoting system may be used in any business, TV, radio, road billboards, printed medias, products, services and any other place where the code(s) advertising, marketing and promoting system will bring some benefits to anyone.
